(19) United States
(12) Patent Application Publication
(10) Pub. No.: US 2006/0007673 A1
(43) Pub. Date: Jan. 12, 2006

(54) Key ring with lights

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 10/888,128

(22) Filed: Jul. 9, 2004

(51) Int. Cl. F21V 33/00

(52) U.S. Cl. 362/116

(57) ABSTRACT

A three dimension housing with at least one end having a parabolic hold located at end portion of said three dimension housing providing a mean of connecting at least one metal key chain, a photoelectrical light includes a rectangular; said photoelectrical light is located inside of said lighting fixture, a power source, a rotational switch, an electrical circuit, an amplifier card and a mosquito repeller; a mosquito repeller is equipped with adjustable frequency regulator, providing mean of different frequencies of ultrasonic waves to repel mosquitoes, a rotational switch is made by metal card A, metal card B, metal card C, upper circuit board, lower circuit board, metal electrical bar and a rotational device.

### REFERENCE

This is a non provisional patent application based on a disclosure document deposit request filed on May. 10, 2004.

### BACKGROUND OF THE PRESENT INVENTION

1 Field of Invention

The present invention relates to a key chain, more particularly to a key chain with an electrical light, an alarm, a rescue request signal, and a mosquito repeller.

2 Description of Related Arts

Key chains are very common for everyone nowadays. People will use them to keep their keys in place for storage purpose or make sure keys are handy for use when needed. However, designs for conventional key chains are dull or so simple that people may not even want to use them since most of those designs are out-fashioned. Second, some key chains might come with a light at one end of housing. However, those lights are very weak in terms of brightness due to its miniature in sizes and the power supply. Therefore, many people will bring along other means of lighting fixture such as miniature flashlights in addition to the key chain holder thereby, it become very inconvenience to bring two separate items when going out.

Thirdly, conventional key chain holders do not have the function of repelling mosquitoes. In most South-east Asia countries, such function is essential since mosquitoes found over there can carry viruses from animals to human beings which might be life-killing. Worsen still, beside cannot provide a mean of repelling mosquitoes, most of conventional key chain holders do not have mean of providing a rescue request signal or alarm when a situation is indeed.

Finally, almost all of those conventional key chain holders with light are having a compressible resilient button as to control a power supply to turn on and off the lighting mean. Such compressible resilient buttons are usually made of polymer which will become insensible as the polymer become oxygenized in times. Moreover, most of the conventional key chain holders provide a light are usually bulky in size.

### SUMMARY OF THE PRESENT INVENTION

A main object of the present invention is to provide a key chain holder with a powerful lighting mean.

Another object of the present invention is to provide a key chain holder with a mean of repelling mosquitoes.

Another object of the present invention is to provide a key chain holder with a mean of providing rescue request signal alarm when a situation is indeed.

Another object of the present invention is to provide a key chain holder with a mean of switch of controlling power supply rather than a polymer compressible resilient button.

Another object of the present invention is to provide a key chain holder with a mean of switch of controlling power supply rather than a polymer compressible resilient button, with a function of providing rescue request signal and alarm, with a mean of repelling mosquitoes and a more powerful lighting mean in a miniature size.

Accordingly, in order to accomplish the above objects, the present invention provides a key chain holder comprising:

a three dimension housing with a at least one end having a parabolic hold located at the end portion of said three dimension housing providing a mean of connecting at least one metal key chain, and

a photoelectrical light includes:

a rectangular A three dimension housing lighting fixture, said photoelectrical light is located inside of said lighting fixture, a power source, a rotational switch, an electrical circuit, an amplifier card and a mosquito repeller; and

a mosquito repeller is equipped with adjustable frequency regulator, providing mean of different frequencies of ultrasonic waves to repel mosquitoes, and

a rotational switch is made by metal card A, metal card B, metal card C, upper circuit board, lower circuit board, metal electrical bar and a rotational device.

### BRIEF DESCRIPTION OF THE DRAWINGS

FIG. 1 is a perspective view of a the present invention, and

FIG. 2 is a lengthwise section thereof.

FIG. 3 is a cross profile thereof,

FIG. 4 is a supine view thereof

FIG. 5 is a bottom view thereof.

FIG. 6 is a front view thereof.

FIG. 7 is a rear view thereof.

FIG. 8 is another side view thereof.

FIG. 9 is a product assembly chart of the present invention thereof.

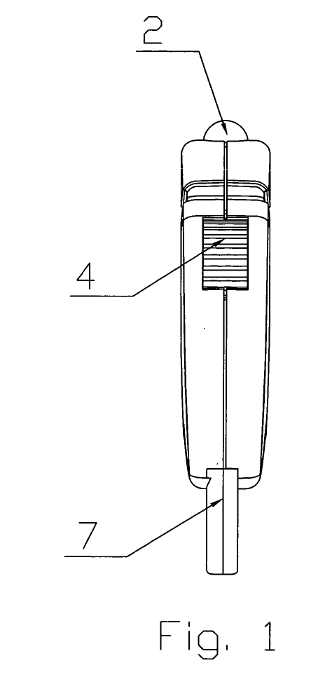

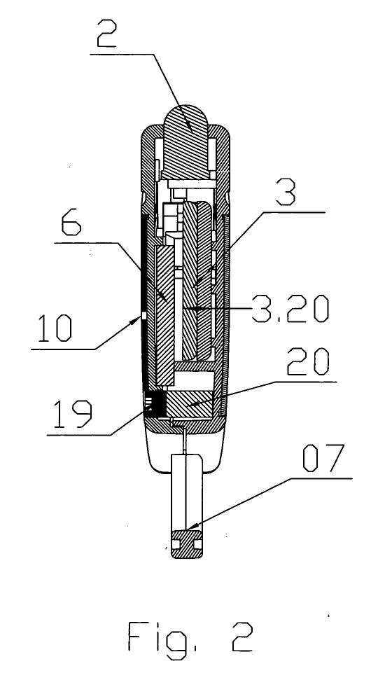

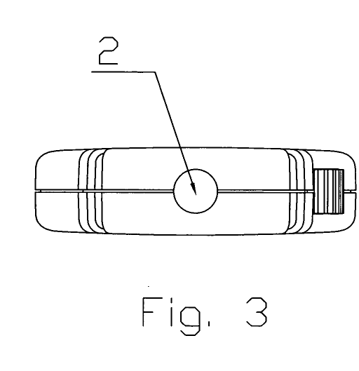

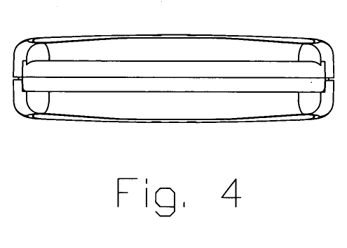

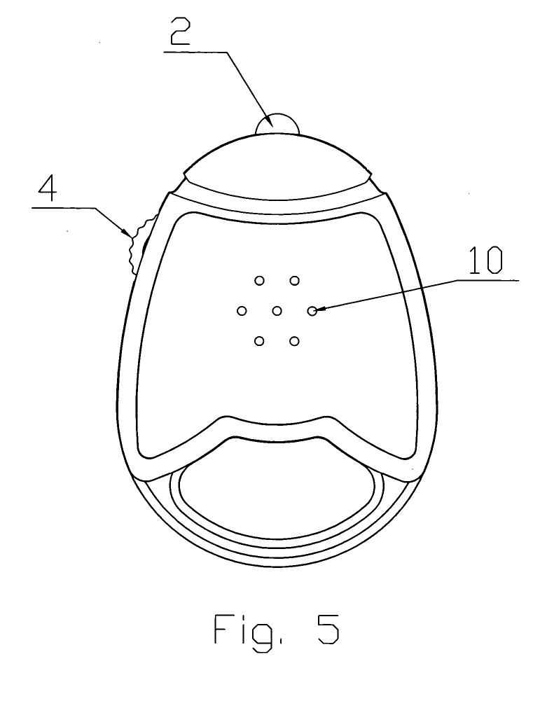

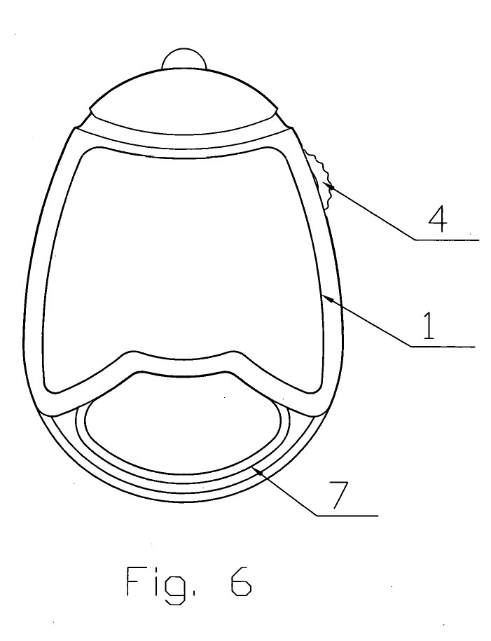

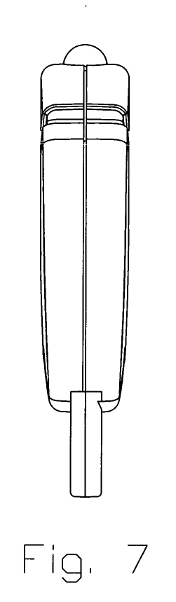

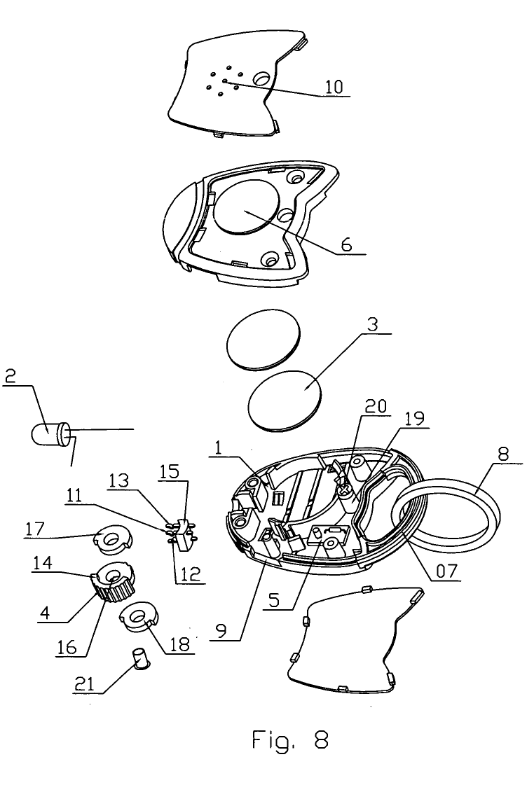

### DETAILED DESCRIPTION OF THE PREFERRED EMBODIMENT

The present invention provides a key chain holder comprising:

a three dimension housing lighting fixture (1), with a at least one end having a parabolic hold located at the end portion of said three dimension housing providing a mean of connecting at least one metal key chain, and, a photoelectrical light (2) which is located inside of said lighting fixture (1), power source (3), rotational switch (4), electrical circuit (5), amplifier card (6) and a mosquito repeller.

Said lighting fixture (1) with a at least one end having a parabolic hold (7) is located at the end portion of said lighting fixture (1) providing a mean of connecting at least one metal key chain thereby constitute a key chain holder (8).

A photoelectrical light (2) is located at the front portion of said lighting fixture (1), at rear portion of said photoelectrical light (2) lays an electrical power (3), said rotational switch (4) is located at an open area under a light fixture (9) which is convenient for user to move around with hand. An amplifier card (6) is on top of said electrical power (3), and alarm sound would come out from a cellular hole (10) at front portion of said lighting fixture (1).

A mosquito repeller (19) is equipped with adjustable frequency regulator (20), providing mean of different frequencies of ultrasonic waves to repel mosquitoes. Said rotational switch (4) is made by metal card A (11), metal card B (12), metal card C (13), upper circuit board (17), lower circuit board (18), metal electrical bar (21) and a rotational device (14). Metal card A (11), B (12), C (13) are set inside of a fixture (15). There is a round hole (16) in middle of a rotational device (14). Said rotational device (14) is attached with upper circuit board (17) and lower circuit board accordingly while electrical bar (21) pass through center hole of said rotational device (14) to secure both upper and lower circuit boards. Said rotational device (14) is fixed among said lighting fixture (1). An electric conduction area on attached upper and lower circuit boards (17 & 18) are also connected with metal card A (11), B (12) and C (13), so when user turns said rotational switch (4), said electrical power (3) passes through light bulb (2) and activate photoelectrical super light. When user turns further on said rotational switch (4), said electrical power (3) passes farther to activate said circuit boards for alarm, rescue request signal or mosquito repeller.

What is claimed is:

1. A three dimension housing with a at least one end having a parabolic hold located at end portion of said three dimension housing providing a mean of connecting at least one metal key chain,
a photoelectrical light,
a rectangular three dimension housing lighting fixture, said photoelectrical light is located inside of said lighting fixture, a power source, a rotational switch, an electrical circuit, an amplifier card and a mosquito repeller,
a mosquito repeller is equipped with adjustable frequency regulator, providing mean of different frequencies of ultrasonic waves to repel mosquitoes, and
a rotational switch is made by metal card A, metal card B, metal card C, upper circuit board, lower circuit board, metal electrical bar and a rotational device.

2. As recited in claim 1, a photoelectrical light is located at the front portion of said lighting fixture, at rear portion of said photoelectrical light lays an electrical power, said rotational switch is located at an open area under a light fixture which is convenient for user to move around with hand. An amplifier card is on top of said electrical power, and alarm sound would come out from a cellular hole at front portion of said lighting fixture.

3. As recited in claim 1, a mosquito repeller is equipped with adjustable frequency regulator, providing mean of different frequencies of ultrasonic waves to repel mosquitoes.

4. As recited in claim 1, a rotational switch is made by metal card A, metal card B, metal card C, upper circuit board, lower circuit board, metal electrical bar and a rotational device. Metal card A, B, C are set inside of a fixture. There is a round hole in middle of a rotational device. Said rotational device is attached with upper circuit board and lower circuit board accordingly while electrical bar pass through center hole of said rotational device to secure both upper and lower circuit boards. Said rotational device is fixed among said lighting fixture.

5. As recited in claim 1, an electric conduction area on attached upper and lower circuit boards are also connected with metal card A, B and C, so when user turns said rotational switch, said electrical power passes through light bulb and activate photoelectrical super light.

6. As recited in claim 1, said rotational switch allows said electrical power passes farther to activate said circuit boards for alarm, rescue request signal or mosquito repeller accordingly.

7. A three dimension housing with a at least one end having a parabolic hold located at end portion of said three dimension housing providing a mean of connecting at least one metal key chain and a thread through the key chain holder located at end portion of said lighting fixture, and put it on neck for lighting purpose,
a photoelectrical light,
a rectangular three dimension housing lighting fixture, said photoelectrical light is located inside of said lighting fixture, a power source, a rotational switch, an electrical circuit, an amplifier card and a mosquito repeller,
a mosquito repeller is equipped with adjustable frequency regulator, providing mean of different frequencies of ultrasonic waves to repel mosquitoes, and
a rotational switch is made by metal card A, metal card B, metal card C, upper circuit board, lower circuit board, metal electrical bar and a rotational device.

8. As recite in claim 7, a rotational switch is made by metal card A, metal card B, metal card C, upper circuit board, lower circuit board, metal electrical bar and a rotational device. Metal card A, B, C are set inside of a fixture. There is a round hole in middle of a rotational device. Said rotational device is attached with upper circuit board and lower circuit board accordingly while electrical bar pass through center hole of said rotational device to secure both upper and lower circuit boards. Said rotational device is fixed among said lighting fixture.

9. As recited in claim 7, a photoelectrical light is located at the front portion of said lighting fixture, at rear portion of said photoelectrical light lays an electrical power, said rotational switch is located at an open area under a light fixture which is convenient for user to move around with hand. An amplifier card is on top of said electrical power, and alarm sound would come out from a cellular hole at front portion of said lighting fixture.

10. As recited in claim 7, a mosquito repeller is equipped with adjustable frequency regulator, providing mean of different frequencies of ultrasonic waves to repel mosquitoes.

11. As recited I claim 7, a rotational switch is made by metal card A, metal card B, metal card C, upper circuit board, lower circuit board, metal electrical bar and a rotational device. Metal card A, B, C are set inside of a fixture. There is a round hole in middle of a rotational device. Said rotational device is attached with upper circuit board and lower circuit board accordingly while electrical bar pass through center hole of said rotational device to secure both upper and lower circuit boards. Said rotational device is fixed among said lighting fixture

12. As recited in claim 7, an electric conduction area on attached upper and lower circuit boards are also connected with metal card A, B and C, so when user turns said rotational switch, said electrical power passes through light bulb and activate photoelectrical super light.

13. As recite in claim 7, said rotational switch allows said electrical power passes farther to activate said circuit boards for alarm, rescue request signal or mosquito repeller accordingly.

14. As recited in claim 1, a rotational switch is made by metal card A, metal card B, metal card C, upper circuit board, lower circuit board, metal electrical bar and a rotational device. There is a round hole in middle of a rotational device. Said rotational device is attached with upper circuit board and lower circuit board accordingly while electrical bar pass through center hole of said rotational device to secure both upper and lower circuit boards. Said rotational device is fixed among said lighting fixture. Said rotational switch allows said electrical power passes farther to activate said circuit boards for alarm, rescue request signal or mosquito repeller accordingly.

15. As recited in claim 7, a rotational switch is made by metal card A, metal card B, metal card C, upper circuit board, lower circuit board, metal electrical bar and a rotational device. There is a round hole in middle of a rotational device. Said rotational device is attached with upper circuit board and lower circuit board accordingly while electrical bar pass through center hole of said rotational device to secure both upper and lower circuit boards. Said rotational device is fixed among said lighting fixture. Said rotational switch allows said electrical power passes farther to activate said circuit boards for alarm, rescue request signal or mosquito repeller accordingly.

16. A rotational switch is made by metal card A, metal card B, metal card C, upper circuit board, lower circuit board, metal electrical bar and a rotational device. There is a round hole in middle of a rotational device. Said rotational device is attached with upper circuit board and lower circuit board accordingly while electrical bar pass through center hole of said rotational device to secure both upper and lower circuit boards. Said rotational device is fixed among said lighting fixture. Said rotational switch allows said electrical power passes farther to activate said circuit boards for alarm, rescue request signal or mosquito repeller accordingly.

17. A rotational switch is made by metal card A, metal card B, metal card C, upper circuit board, lower circuit board, metal electrical bar and a rotational device. There is a round hole in middle of a rotational device. Said rotational device is attached with upper circuit board and lower circuit board accordingly while electrical bar pass through center hole of said rotational device to secure both upper and lower circuit boards. Said rotational device is fixed among said lighting fixture. Said rotational switch allows said electrical power passes farther to activate said circuit boards and adjust volume level of rescue single accordingly.

18. A rotational switch is made by metal card A, metal card B, metal card C, upper circuit board, lower circuit board, metal electrical bar and a rotational device. There is a round hole in middle of a rotational device. Said rotational device is attached with upper circuit board and lower circuit board accordingly while electrical bar pass through center hole of said rotational device to secure both upper and lower circuit boards. Said rotational device is fixed among said lighting fixture. Said rotational switch allows said electrical power passes farther to activate said circuit boards and adjust volume level of alarm accordingly.

19. A rotational switch is made by metal card A, metal card B, metal card C, upper circuit board, lower circuit board, metal electrical bar and a rotational device. There is a round hole in middle of a rotational device. Said rotational device is attached with upper circuit board and lower circuit board accordingly while electrical bar pass through center hole of said rotational device to secure both upper and lower circuit boards. Said rotational device is fixed among said lighting fixture. Said rotational switch allows said electrical power passes farther to activate said circuit boards and adjust level of brightness for lighting fixture accordingly.

20. A rotational switch is made by metal card A, metal card B, metal card C, upper circuit board, lower circuit board, metal electrical bar and a rotational device. There is a round hole in middle of a rotational device. Said rotational device is attached with upper circuit board and lower circuit board accordingly while electrical bar pass through center hole of said rotational device to secure both upper and lower circuit boards. Said rotational device is fixed among said lighting fixture. Said rotational switch allows said electrical power passes farther to activate said circuit boards and adjust level of brightness different frequencies of ultrasonic waves to repel mosquitoes accordingly.
